(19) United States
(12) Patent Application Publication
(10) Pub. No.: US 2010/0112286 A1
(43) Pub. Date: May 6, 2010

(54) SUPERHYDROPHOBIC SURFACES

(76) Inventors: Vaibhav A. Bahadur, Cambridge, MA (US); Suresh V. Garimella, West Lafayette, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 12/611,411

(22) Filed: Nov. 3, 2009

Related U.S. Application Data
(60) Provisional application No. 61/110,755, filed on Nov. 3, 2008.

(51) Int. Cl. B32B 3/00; B05D 5/00

(52) U.S. Cl. 428/141; 427/243

(57) ABSTRACT

Control and switching of liquid droplet states on artificially structured surfaces have applications in the field of microfluidics. The present work introduces the concept of using structured surfaces consisting of non-communicating (closed cell) roughness elements to prevent the transition of a droplet from the Cassie to the Wenzel state (which would result in the irreversible loss of the superhydrophobic non-wetting properties of the surface). The use of non-communicating roughness elements leads to a confinement of the medium under the droplet in its Cassie state. Transition to the Wenzel state on such surfaces many include expulsion of this confined medium, which offers increased resistance to the Wenzel transition unlike surfaces consisting of communicating (open cell) roughness elements. This enhances the robustness of the Cassie state and significantly minimizes the possibility of the Cassie-Wenzel transition under the influence of any external wetting pressure (pressure resulting from self weight of the droplet, dynamic pressure due to droplet impact on the surface, or electrowetting-induced pressure on the droplet). The resistance to the Cassie-Wenzel transition can be further increased by utilizing surfaces with nanostructured (instead of microstructured) non-communicating elements, since the resistance is inversely related to the dimension of the roughness element. The resistance of a surface to the Wenzel transition is measured in terms of the electrowetting (EW) voltage used to trigger this transition. Surfaces with noncommunicating roughness elements (closed cells) exhibited significantly higher voltages to trigger the Wenzel transition than corresponding surfaces with communicating roughness elements.

### CROSS REFERENCE TO RELATED APPLICATION

This application claims the benefit of priority to U.S. Provisional Patent Application Ser. No. 61/110,755, filed Nov. 3, 2008, incorporated herein by reference.

### FIELD OF THE INVENTION

The present invention pertains to methods and apparatus that alter the ability to wet a surface of an object.

### BACKGROUND OF THE INVENTION

The Cassie state is a low-friction state because of the reduced contact area of the droplet. The Wenzel state is associated with a large solid-liquid contact area which is desirable for enhanced heat transfer or for chemical reaction applications. In many microfluidic devices, it is desirable to transport the droplet in the Cassie state, since the actuation force is low compared to the force to transport the droplet on a smooth surface. However, the surface should be designed such that the possibility of a transition to the Wenzel state is avoided in such applications, since the droplet is difficult to move in the Wenzel state.

The concept of EWOD (ElectroWetting on Dielectric) includes the premise of an effective reduction in the dielectric-liquid interfacial energy by the application of a voltage between a conducting droplet and an underlying dielectric layer. EW can be used to demonstrate droplet actuation on smooth surfaces and in other microfluidic operations such as the formation, mixing and splitting of droplets.

Electrowetting is a tool for droplet state control on rough surfaces. The EW-induced Cassie-Wenzel transition has been studied and demonstrated by multiple researchers on microstructured and nanostructured surfaces. One characteristic of some studies so far has been the lack of reversibility of the Cassie-Wenzel transition upon removal of the EW voltage. The main reasons for the lack of reversibility include the presence of an energy barrier for the reverse transition and dissipative friction forces.

Various embodiments of the present invention pertain to novel and unobvious ways of increasing the resistance of a droplet on a surface to the Wenzel state, including apparatus and methods for making the surface of an object more Wenzel resistant.

### SUMMARY OF THE INVENTION

One aspect of some embodiments of the present invention are cratered surfaces (non-communicating (closed cell) surfaces) that offer increased resistance to droplet transition to the Wenzel state than equivalent pillared surfaces (communicating (open cell) surfaces). The presence of air trapped inside the non-communicating craters and the resistance to fluid motion offered by the crater boundaries and corners are two sources of this increased resistance to the Wenzel transition.

The resistance offered by cratered surfaces to the Cassie-Wenzel transition can be measured in terms of the electrowetting (EW) voltage used to trigger the transition. The EW voltage to trigger the Cassie-Wenzel transition is higher for cratered surfaces (non-communicating roughness elements) than equivalent pillared surfaces (communicating roughness elements). The use of non-communicating roughness elements offers possibilities for the development of robust superhydrophobic surfaces, in which the possibility of a transition to the Wenzel state and the accompanying loss of superhydrophobic properties is minimized.

One use of the technology is for the design of superhydrophobic surfaces for transporting liquid droplets. Embodiments of the present invention present novel approaches to the design of robust superhydrophobic surfaces. Liquid droplet transport has applications in biomedical engineering, microfluidics, lab-on-a-chip systems, electrowetting systems and microelectronics thermal management. Superhydrophobic surfaces also can lead to the development of large-scale low-friction surfaces and self-cleaning surfaces. Various embodiments of the present invention pertain to the design of superhydrophobic surfaces in the above mentioned fields.

One aspect of some embodiments of the present invention pertains to an apparatus for supporting a droplet of liquid. Some embodiments include a substrate having a layer and a plurality of closed cells, each cell being open to the surface. Each cell has characteristic dimensions t and a which define a parameter Φ as follows:

$$φ = 1 - \frac{{a}^{2}}{{( a + 2 t )}^{2}}$$

Furthermore, the characteristic height h of each cell is predetermined such that:

$$( 1.5 ) \times h > [ φ - 1 - \frac{( 1 - φ )}{cos {θ}_{0}} ] \frac{{( a + 2 t )}^{2}}{4 a}$$

where theta_{zero} is the contact angle of a droplet of the liquid on a flat (smooth) surface in.

Another aspect of one embodiment of the present invention includes a method for supporting a droplet of liquid, including fabricating an ordered layer of cells on a substrate. Still other embodiments include establishing a typical geometry for the cells having roughness parameters rₘ and Φ such that:

$$cos {θ}_{0} < - \frac{1 - φ}{{r}_{m} - φ}$$

where θ₀ the contact angle of a droplet of the liquid on a flat (smooth) surface. Yet other embodiments include placing a droplet on the surface, and sealing the openings of a portion of the cells with the droplet, and substantially trapping air in the closed interior of the portion of the cells.

Yet another aspect of some embodiments of the present invention pertains to an apparatus for supporting a droplet of liquid. Some embodiments include a substrate having a layer with a planar surface, a layer including a plurality of closed interior cells. Each cell includes an opening at the surface. Sidewalls of a cell are joined to one another at a corresponding one of a first plurality of interior corners, each interior corner having an included angle less than about one hundred thirty-five degrees. Each opening includes at least one exterior corner having an exterior angle greater than about two hundred and forty degrees.

Yet other embodiments of the present invention pertain to closed cell roughness features fabricated on a surface that result in a droplet of liquid on the surface having increased resistance to a transition to the Wenzel state. Preferably, the closed cells can be characterized by a roughness element Φ that is less than about one-half, and more preferably in some embodiments less than about three-tenths. Further, the dimensions of the cells are selected such that the roughness parameter rₘ is greater than about 1.9, and more preferably in some embodiments above 2.5. Further, in some embodiments the height of the closed interior of the cell from the bottom to the top droplet-supporting surface is selected to be greater than about one-third of a characteristic dimension of the cell opening. In some embodiments, this ratio is a/h, such as discussed herein.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is excessive and unnecessary.

### BRIEF DESCRIPTION OF THE DRAWINGS

FIG. 1: Schematic representation of droplet states on rough surfaces: (a) Cassie state, and (b) Wenzel state.

FIG. 1(c): Schematic representation of the spreading of a droplet on a flat surface upon the application of an electrowetting voltage V.

FIG. 2a: Rough surfaces with communicating (open cell) roughness elements.

FIG. 2b: Rough surfaces with non-communicating (closed cell) roughness elements according to one embodiment of the present invention.

FIG. 3a: Scanning electron microscopy (SEM) image of microcratered surface 2.

FIG. 3b: Scanning electron microscopy (SEM) image of microcratered surface 9, according to another embodiment of the present invention.

FIG. 3c: Scanning electron microscopy (SEM) image of microcratered surface 11, according to another embodiment of the present invention.

FIG. 4: Deionized water droplet on cratered surface 9 in (a) Cassie state at no EW voltage, and (b) Wenzel state at an EW voltage of 100 V.

FIG. 5: Photograph in pairs (a) and (c) showing droplets on two different surfaces, both according to different embodiments of the present invention, in the Cassie state, while parts (b) and (d) show the residual ring of smaller droplets left behind after an EW voltage of 100 V is applied, removed and the droplet gently blown off.

FIG. 6(a): A schematic representation of the top plan view of a surface according to one embodiment of the present invention.

FIG. 6(b): A schematic representation of the top plan view of a surface according to another embodiment of the present invention.

### LIST OF VARIABLE NAMES

| | |
|---|---|
| φ | ratio of the area of the top surface of the roughness elements to the |
| | total base area of the substrate |
| θ₀ | contact angle of the droplet on a surface |
| θ_{C} | apparent contact angle of a droplet in the Cassie state |
| θ_{W} | apparent contact angle of a droplet in a Wenzel state |
| θ_{C}^{E} | contact angle of a droplet in the electrowetted Cassie state |
| θ_{W}^{E} | contact angle of a droplet in the electrowetted Wenzel state |
| h | cell depth |
| η | electrowetting number |
| rₘ | roughness parameter |
| 2t | cell-wall thickness |
| k | dielectric constant of the dielectric layer |
| ε₀ | permittivity of vacuum |
| V | electrowetting voltage |
| d | thickness of the dielectric layer |
| γ_{LA}⁰ | surface tension of the liquid |

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that must be included in all embodiments, unless otherwise stated.

The use of an N-series prefix for an element number (NXX.XX) refers to an element that is the same as the non-prefixed element (XX.XX), except as shown and described thereafter. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 and 20.1 that are the same, since these common features are apparent to a person of ordinary skill in the related field of technology. Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only. Further, with discussion pertaining to a specific composition of matter, that description is by example only, and does not limit the applicability of other species of that composition, nor does it limit the applicability of other compositions unrelated to the cited composition.

Some embodiments of the present invention pertain to the design of rough surfaces for transporting liquid droplets in microfluidic applications. One aspect of some embodiments is the use of non-communicating (closed cell) roughness elements for designing superhydrophobic surfaces (rough surfaces on which the droplet rests on top of the roughness elements). In some embodiments, a non-communicating roughness element is a feature of the surface that defines cell (or pocket or pore or crater) having a closed interior volume and an open aperture at the top. The closed cell can be covered by the placement of a droplet thereupon, such that the surface of the droplet closes the open aperture of the pocket. Since the aperture is closed by the bottom surface of the droplet, any substance (such as a gas) within the otherwise closed interior is trapped once the pocket is closed by the droplet. Any fluid communication from one pocket to an adjacent pocket is substantially discouraged, or in most cases eliminated, by the integrity of the walls and floor pocket and the elimination of flow out of the pocket aperture by the fitment of the drop bottom surface across the aperture. Closed cells are also referred to herein as non-communicating cells or non-communicating roughness elements.

In such embodiments, the use of non-communicating roughness elements results in air being trapped between the droplet base and the roughness elements below the droplet. The droplet cannot substantially sink and wet the surface completely under any external force because the trapped air cannot be expelled (the roughness elements are non-fluid communicating). This increases the robustness of the initial superhydrophobic droplet state (in which the droplet rests on top of roughness elements) and prevents or reduces inadvertent changes in the droplet state. The droplet can then be transported in this robust superhydrophobic state using electrowetting actuation (application of electrical voltages) or any another actuation technique.

In some embodiments of the present invention, it has been found that surfaces with non-communicating roughness elements in the microscale or nanoscale regime (microstructured of nanostructured closed cell surfaces) have a higher resistance to the Cassie-Wenzel transition than surfaces with length scales in the microscale and higher regimes. The Cassie-Wenzel transition results in a complete and irreversible loss of the superhydrophobic properties of the surface, which is undesirable in many applications. As used herein, the robustness of the Cassie state refers to increased resistance to any external wetting pressure which causes the Cassie-Wenzel transition. The wetting pressures include (but are not limited to) the pressure resulting from the self weight of the droplet, the dynamic pressure and water hammer pressure due to droplet impact on the surface, or electrowetting-induced pressure on the droplet.

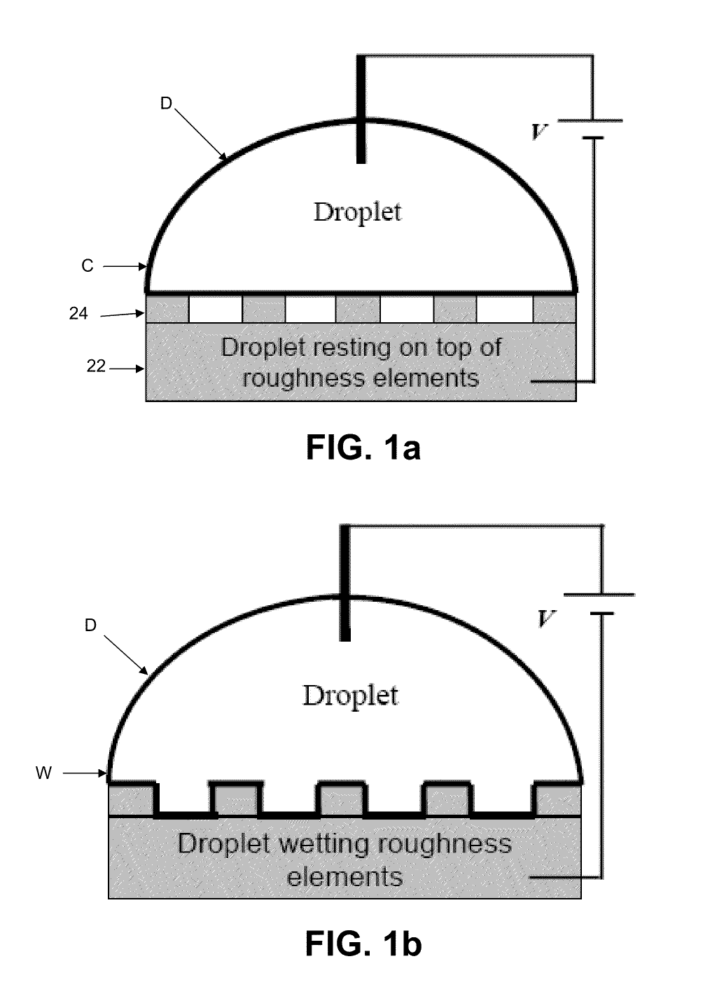

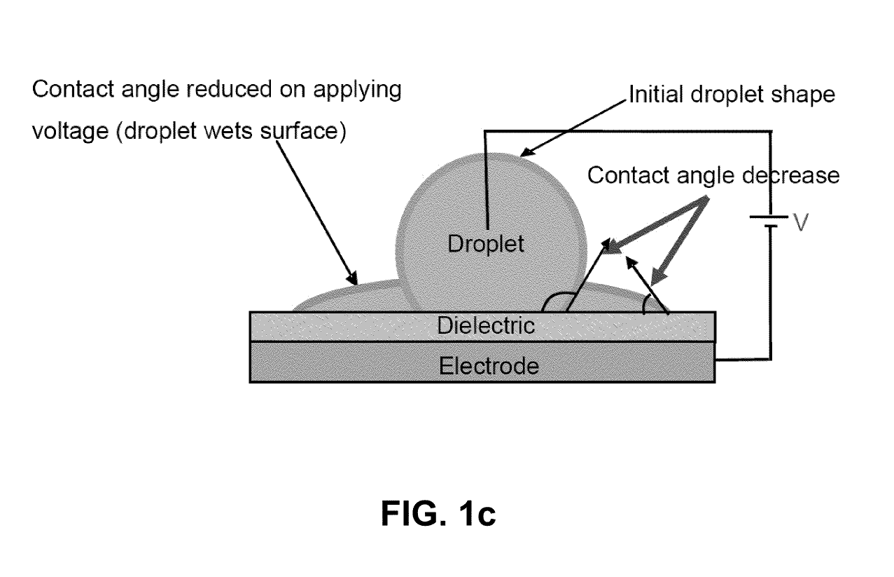

Other embodiments of the present invention pertain to the states of liquid droplets on rough (artificially or naturally structured) surfaces. The influence of surface roughness on liquid droplet morphology can be understood by a study of two extreme situations in which a droplet can exist on a rough surface. In the Cassie (superhydrophobic) state (FIG. 1a), the droplet base rests on the tips of the roughness elements; consequently the droplet is in composite contact with air and solid at its base. In the Wenzel state (FIG. 1b), the droplet fills the space between the roughness elements and is in intimate contact with the solid surface. The robustness of the superhydrophobic state is obtained in some technologies by designing the surfaces such that the energy required for the droplet to sink down is high. This criterion can necessitate the use of tall pillars, which may not always be feasible due to fabrication limitations.

Some embodiments of the present invention propose a different approach for the design of robust superhydrophobic surfaces. The robustness of the superhydrophobic state is enhanced by the noncommunicating roughness elements; therefore the requirement of tall roughness elements is eliminated. In some embodiments the robustness of the superhydrophobic state is enhanced by the use of a cell depth that is greater than a minimum depth, the minimum depth being decided by the particular surface and liquid combination and the parameter Φ. Various embodiments of the present invention enable the development of surfaces on which the robustness of the superhydrophobic state is greater than that achieved by other alternatives

The wettability of a liquid droplet on a rough surface has applications in the fields of lab-on-chip systems, biomedical devices and other MEMS-based fluidic devices, among others. One aspect of some embodiments has been the development of superhydrophobic surfaces on which the resistance to droplet motion and contact angle hysteresis are greatly minimized. This reduced resistance to droplet motion is the result of the droplet attaining a Cassie state on the surface as depicted in FIG. 1a. In the Cassie state (FIG. 1a) the droplet base rests only on the tips of the roughness elements; consequently, the base of the droplet is in composite contact with air and the tops of the protruding elements on the solid substrate. Another state of wetting is the Wenzel state (FIG. 1b) in which the droplet wets the roughness elements completely or near-completely and is in contact with the solid substrate. Both Cassie and Wenzel droplet formation is possible on the same surface depending on the way the droplets are formed. The surface energy of the Cassie and Wenzel droplets is minimized when the apparent (macroscopic) contact angle equals that predicted by the Cassie and Wenzel equations. However, the Cassie and Wenzel droplets differ in their surface energies, and the stable equilibrium state of the droplet corresponds to the state which has the lower energy.

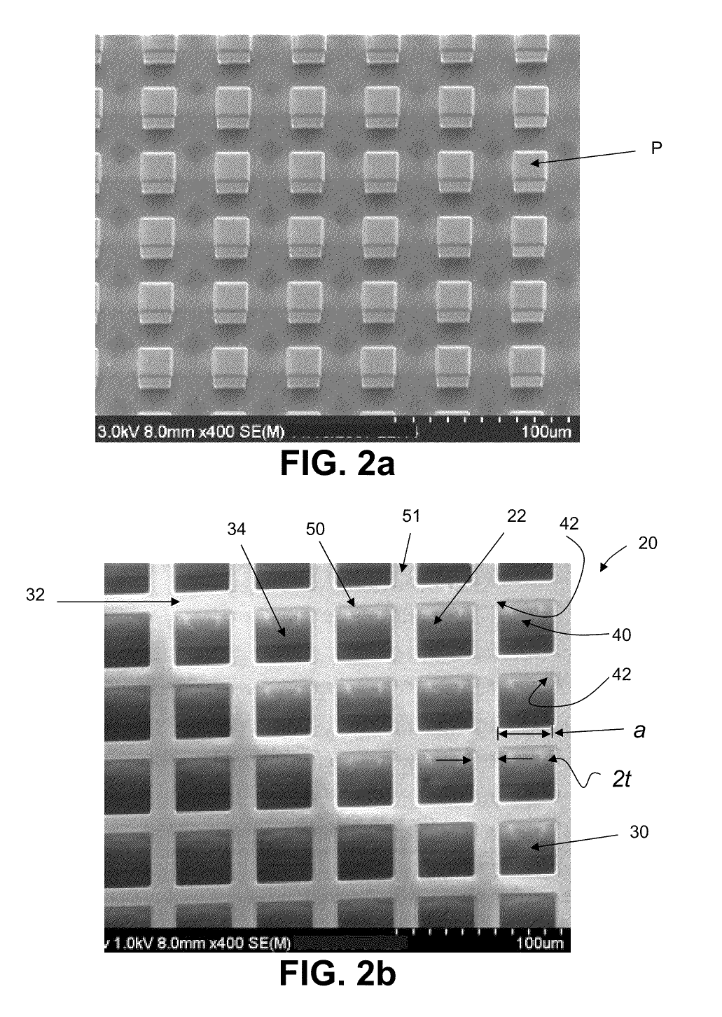

Some studies of droplet morphology on rough surfaces have examined surfaces in which the roughness-causing elements are communicating. Pillared surfaces (FIGS. 1a and 2a) and surfaces with roughness elements including carbon nanotubes or nanowires are examples of surfaces in which the medium between the roughness-causing elements (air in most studies) is communicating in nature. Consequently, this medium is expelled out of the surface when the droplet transitions to the Wenzel state.

Some embodiments of the present invention pertain to droplet transition in a situation in which the medium is confined to remain in the substrate and does not escape the surface from the sides. Such a situation occurs when the roughness-causing elements are noncommunicating in nature. In such surfaces the medium is trapped below the droplet (in the Cassie state) and the non-communicating element. In order to wet and fill up the element and reach the Wenzel state, the droplet will expel this medium; this expulsion may not always happen and will depend on the size of the element and the strength of the transition-causing effect. Consequently, it has been found that surfaces with non-communicating elements (example: FIG. 2b) present a higher resistance to the Cassie-Wenzel transition than those with communicating elements.

This increase in the resistance to a Wenzel transition has applications in the field of droplet-based microfluidics. The Cassie state is associated with low resistance to droplet motion. The surface is preferably designed such that the chances of a transition to the Wenzel state are minimized. This can be achieved by designing the surface such that the energy barrier to transition to the Wenzel state is high. This can also be accomplished by using a surface with non-communicating elements instead of the usual pillared surfaces; the medium below the droplet in the Cassie state will then inhibit transition to the Wenzel state. This trapped medium makes the Cassie state more robust, and the possibility of a Wenzel transition resulting from stray vibrations or other forms of energy input will be minimized.

It has also been found that the transition to the Wenzel state can be discouraged by the use of sharper-cornered features in the plane of the surface, and also by reducing (or eliminating) rounded surface features, especially rounded (or radiused or filleted) corners. As one example, some embodiments of the present invention pertain to surfaces in which the opening of the cells at the surface are comprised substantially of straight line segments (such straight line segments being projections of the cell wall) that intersect at sharp, interior corners. In some embodiments, the sharpness is achieved by designing the cell opening as the intersection of straight lines, and not indicating a radius in the interior corner. It is understood that fabrication processes, including photolithography, are limited in the corner sharpness that can be obtained, such limitations resulting from the inherent physics or chemistry of the process, or in the implementation of the physics or chemistry. However, in such cases it is preferred that the designer indicate that the corner be represented as the simple intersection of straight lines. In yet other embodiments, it is appreciated that the corners can be radiused, and preferably the radius of the corner is less than one-tenth of the length of the straight line segments that form the corner. In yet other embodiments, it is preferable that the radius be less than one-hundredth of the length of the straight line segments that define the corner.

In yet another embodiment of the present invention, the hydrophobicity of the surface is enhanced by the placement of exterior corners around the cell opening. In some embodiments this is achieved by the creation of additional pairs of adjacent cell walls that project into and are joined at the interior of the cell. In some embodiments this is achieved by designing an ordered array of cells of a first hierarchy (examples: triangular, rectangular, pentagonal, or hexagonal shapes, regular or irregular; and further polygonal shapes defined generally by straight line segments). A second feature of smaller size and different hierarchial order is then superimposed on the cell wall of the first pattern. As examples, the higher ordered elements could be triangular shaped or rectangular shapes superimposed on the cell walls, such that the corners of the higher ordered shapes extend toward the interior of the cell opening as exterior corners. Preferably, the higher ordered shape extends downward within the cell, forming additional walls of the cell, in order to simplify fabrication. However, the present invention also contemplates those embodiments in which the surface of the structure has a geometric pattern that is partly shared by the walls of the cell, but also including other features that act as exterior-cornered ledges extending from the tops of the cell walls along the surface.

One embodiment of the present invention pertains to apparatus and methods for increased resistance to the Cassie-Wenzel transition offered by a surface with non-communicating roughness elements. This increase in resistance is quantified by a measurement of the EW voltage that triggers a transition to the Wenzel state.

The equations governing the design of surfaces according to some embodiments are briefly described in this section. The apparent contact angle θ_{C} of a droplet in the Cassie state is obtained from the energy minimization principle as:

cos θ_{c}=−1+Φ(1+cos θ₀) (1)

where φ is the ratio of the area of the top surface of the roughness elements to the total base area of the substrate, and θ₀ is the contact angle of the droplet on a flat surface. For a droplet in the Wenzel state, the apparent contact angle θ_{W} is similarly obtained as:

cos θ_{W}=rₘ cos θ₀ (2)

where rₘ is the surface roughness defined as the ratio of the total surface area (including the sides and base) of the roughness elements to the projected surface area (not including the sides) of the roughness elements.

There are expressions for the apparent contact angle of a droplet resting on a structured surface in the presence of an EW voltage. The surface was electrically conducting and was coated with a thin dielectric layer of thickness d and dielectric constant k that conformed to the surface roughness features. An EW field was established across the dielectric by electrodes contacting the conducting droplet and the electrically conducting substrate. An energy minimization framework was used to estimate the contact angle θ_{c}^{E} of a droplet in the Cassie state under the influence of an EW voltage V as:

cos θ_{C}^{E}=−1+Φ(1+cos θ₀+η) (3)

where η is the electrowetting number expressed as:

$$η = \frac{k {ɛ}_{0} {V}^{2}}{2 d {γ}_{LA}^{0}} \qquad ( 4 )$$

A similar approach can be used to estimate the apparent contact angle θ_{W}^{E} of a Wenzel drop under the influence of an EW voltage as:

cos θ_{W}^{E}=−rₘ(cos θ₀+η) (5)

The surface energy of a constant-volume droplet can be expressed generally in terms of the apparent contact angle. Furthermore, the droplet surface energy increases with the apparent contact angle of the droplet. This implies that the lower of the Cassie and Wenzel angles corresponds to the stable equilibrium position of the droplet. EW can be employed to design surfaces on which the droplet states are manipulated dynamically by changing the relative energy content (and relative stability) of the Cassie and Wenzel states. The surfaces are preferably designed such that the Cassie state is more favorable energetically than the Wenzel state in the absence of an EW voltage, which is satisfied by the following relation between the surface roughness parameters rₘ and Φ:

$$cos {θ}_{0} < - \frac{1 - φ}{{r}_{m} - φ} \qquad ( 6 )$$

Furthermore, in addition to the above requirements it is helpful that the contact angle θ₀ of the droplet on a flat surface be greater than 90 degrees.

Equation (6) can be further rearranged in terms of a roughness parameter rₘ (especially for those embodiments in which rₘ includes a relationship defining the height of the cell) as follows:

rₘ>Φ+(Φ−1)/(Cos θ₀) (6.5)

Application of an EW voltage can lower the energy of the electrowetted Wenzel state in comparison to the electrowetted Cassie state and thereby trigger a transition to the Wenzel state. The Cassie-Wenzel transition can be achieved without activation energy to overcome the energy barrier (to transition), if the EW number η satisfies:

(η>−cos θ₀) (7)

Equation 7 predicts the EW voltage for triggering the Cassie-Wenzel transition on any structured surface (since the EW voltage in Equation 7 does not depend on surface parameters rₘ and Φ). Equations 1-7 offer one basis of rough-surface design in various embodiments of the present invention.

One aspect of some of the experiments was to demonstrate that a surface with noncommunicating roughness elements can resist transition to the Wenzel state under the application of an electrical voltage. The surfaces utilized consisted of square-shaped craters in a silicon wafer; therefore, these surfaces are referred to as cratered surfaces in the following.

The minimum feature size of the crater walls was fixed to be greater than 10 μm for ease of fabrication. For a surface morphology described by square cells of width a, crater-wall thickness 2t and crater depth h, the roughness parameters rₘ and Φ can be expressed

$$\begin{matrix}{r}_{m} = 1 + \frac{4 ah}{{( a + 2 t )}^{2}} \\ and & ( 8 ) \\ φ = 1 - \frac{{a}^{2}}{{( a + 2 t )}^{2}} & ( 9 )\end{matrix}$$

It is understood that the above expressions (8) and (9) for surface roughness parameters pertain to the square cells shown and described herein. It is understood that the roughness parameters can be expressed in other terms known to those skilled in the art for other configurations of cells. The above relationships (8) and (9) can be combined and solved for a minimum h that, in some embodiments, results in surface features with superhydrophobic properties:

$$h > [ φ - 1 - \frac{( 1 - φ )}{cos {θ}_{0}} ] \frac{{( a + 2 t )}^{2}}{4 a} \qquad ( 10 )$$

It has been found that surfaces fabricated with microscale or nanoscale features exhibit super hydrophobicity if, as in some embodiments, the surface includes closed cells having a depth h that is greater than two-thirds of the minimum depth defined by equation (10). In yet other embodiments, it is preferable that the depth h is greater than three-fourths of the minimum depth defined by equation (10). In yet other embodiments, hydrophobicity is enhanced by the use of closed cells having a depth h that is greater than about nine-tenths of the minimum depth defined by equation (10).

Ten surfaces of varying surface parameters (rₘ, φ and h) were fabricated and characterized. Table 1 shows the surface parameters rₘ and φ, crater width a, crater-wall thickness 2t and the crater depth h of the ten surfaces which were designed for experimentation with water droplets. The minimum feature size in these cratered surfaces was the wall thickness; two wall thicknesses of 10 μm and 15 μm were selected for device fabrication. The ten surfaces are arranged in increasing order of the crater depth in Table 1.

TABLE 1
Specifications of the micro-cratered surfaces designed for the
experiments

| Surface | | | | | | CA(obs) | CA(predicted) | Observed |
|---|---|---|---|---|---|---|---|---|
| Number | φ | rₘ | h (μm) | a (μm) | 2t (μm) | (deg) | (deg) | State |
| 1 | 0.2 | 1.41 | 10.8 | 84 | 10 | 141.4 | (152.2 - Cassie, | Wenzel |
| | | | | | | | 126.6 - Wenzel) | |
| 2 | 0.15 | 1.21 | 10.8 | 177 | 15 | 151.2 | (156 - Cassie, | Wenzel |
| | | | | | | | 120 - Wenzel) | |
| 3 | 0.2 | 1.27 | 10.8 | 126 | 15 | 150.2 | (152.2 - Cassie, | Wenzel |
| | | | | | | | 122.5 - Wenzel) | |
| 4 | 0.5 | 1.60 | 10.8 | 35 | 15 | 134.2 | (135.3 - Cassie, | Wenzel |
| | | | | | | | 132.5 - Wenzel) | |
| 5 | 0.2 | 1.70 | 27.5 | 126 | 15 | 141.7 | (152.2 - Cassie, | Wenzel |
| | | | | | | | 135.9 - Wenzel) | |
| 6 | 0.2 | 2.06 | 42 | 126 | 15 | 157.6 | 152.2 | Cassie |
| 7 | 0.2 | 4.25 | 85.5 | 84 | 10 | 144.1 | 152.2 | Cassie |
| 8 | 0.15 | 2.64 | 85.5 | 177 | 15 | 148.9 | 156 | Cassie |
| 9 | 0.2 | 3.17 | 85.5 | 126 | 15 | 144.7 | 152.2 | Cassie |
| 10 | 0.5 | 5.79 | 85.5 | 35 | 15 | 131.2 | 135.3 | Cassie |

The microcratered surfaces were fabricated in the Birck Nanotechnology Center at Purdue University. All the chemicals and etchants utilized during the fabrication process were of clean-room grade. Highly doped (low electrical resistivity) silicon (<100> orientation) wafers covered with a layer of 1 μm thermally grown oxide were used as the substrate. The low electrical resistivity corresponds to the requisite electrical conductivity for the application of an EW voltage.

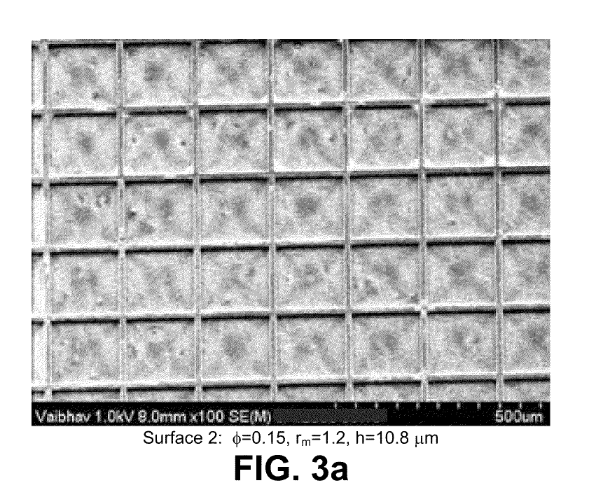

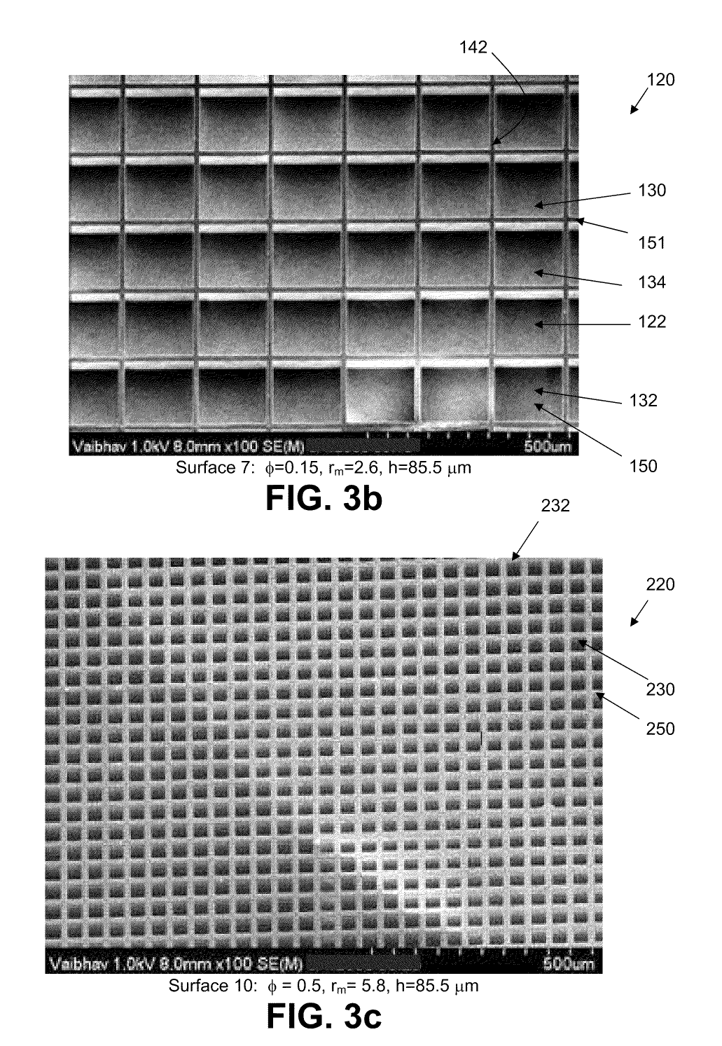

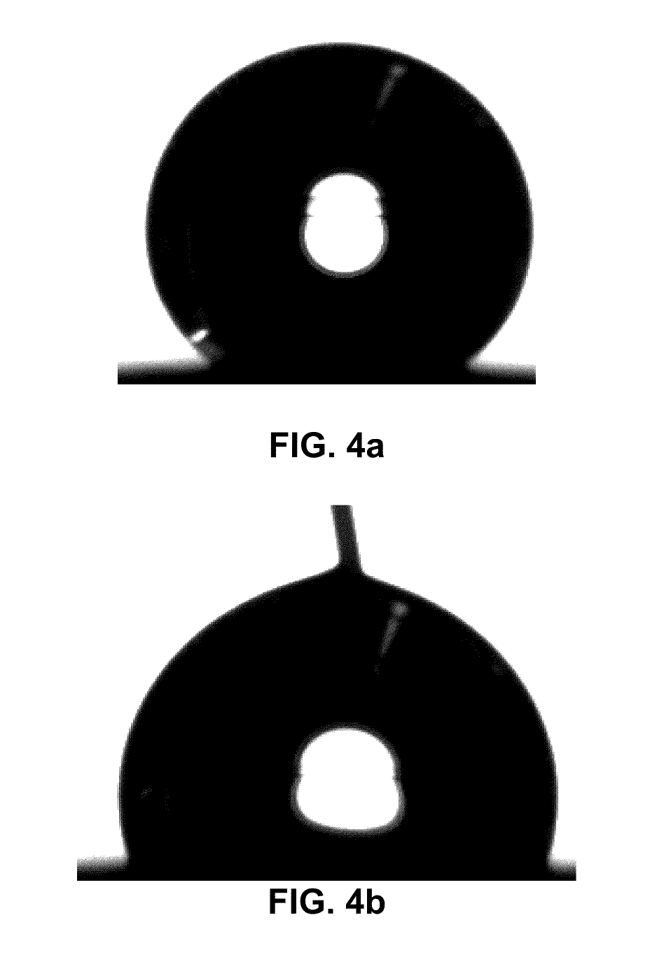

Positive photoresist was photolithographically patterned using a dark-field mask to selectively mask the underlying oxide layer by creating features representing the crater walls. Silicon dioxide was then selectively etched away via a wet etch process. The patterned oxide layer served as the mask for a subsequent Deep Reactive Ion Etch (DRIE) process using SF₆ and C₄F₈, which was employed to fabricate the silicon pillars. The silicon pillars were then conformally coated with a Parylene C dielectric layer of thickness 0.5 μm by physical vapor deposition. Finally, 1% by weight of Teflon AF1600 (DuPont, Wilmington, Del.) in a solution of FC 77 (3M, St. Paul, Minn.) was spun on the structured surface to impart superhydrophobicity. Both the Parylene C and Teflon deposition processes led to conformal coatings as verified from scanning electron microscope (SEM) images. FIGS. 3a and 3b show SEM images of two representative cratered surfaces of the lowest and highest crater depths, respectively, after the Teflon deposition step.

Surfaces of four different crater depths were fabricated as shown in Table 1. FIGS. 3(a)-(c) show SEM images of these three micro-cratered surfaces. The micro-cratered surfaces presented in FIG. 3 span a range of the φ values (0.15-0.5), a range of rm values (1.2-5.8) and a range of crater depths (10.8-85.5 μm).

For purposes of comparison, twelve pillared surfaces on a silicon substrate (FIG. 2a is an illustrative image) were fabricated and characterized for the Cassie-Wenzel transition. These pillared surfaces are further described in the paper published by the American Chemical Society in Langmuir 2008, 24, 8338-8345, “Electrowetting-Based Control of Droplet Transition and Morphology on Artificially Microstructured Surfaces,” incorporated herein by reference. The surfaces consisted of Φ, rₘ and pillar height values ranging from (0.22-0.55), (1.3-4.4) and (8.3-78.4 μm), respectively.

FIG. 2a shows a rough surface consisting of pillars; these surface roughness elements are communicating in nature. FIG. 2b shows a surface in which the roughness elements are square cells. The cells are non-communicating in nature and the medium in one cell (pocket) cannot flow to the adjacent cell because of the groove walls. On such surfaces the medium trapped below the droplet in the Cassie state will prevent transition to the Wenzel state. The surface in FIG. 2b is one example of a robust superhydrophobic surface on which the transition to the Wenzel state under some external phenomena on the droplet (electrical or mechanical) is discouraged or prevented. Experiments have been conducted using these surfaces to validate the robust nature of the superhydrophobic state on such surfaces.

Although what has been shown and described are cell geometries that are substantially square, other embodiments of the present invention are not so limited. The present invention contemplates any polygonal structure for the cells, whether of regular or irregular sides. Preferably, the cell walls have six or fewer sides, and in some embodiments, the sides are of equal width. Yet other embodiments include cell walls having one or more curved walls, and especially those embodiments in which the curved cell shapes are of a first order, with a pattern of second, higher ordered shapes imposed thereon in order to achieve a plurality of sharp corners for support of the droplet.

Referring to FIG. 2b, there is shown an apparatus 20 according to one embodiment of the present invention. Apparatus 20, which can be part of any object in which hydrophobicity is desired, includes a substrate 22 onto which a layer 24 of cells 30 is fabricated. The present invention contemplates any type of material and any type of fabrication process.

Cells 30 are preferably fabricated in a repetitive, ordered arrangement 32. As best seen in FIGS. 2b, 3b, and 3c, in some embodiments the pattern is the same in both longitudinal and lateral directions (top to bottom and side to side, respectively, as seen in FIG. 2b). However, any pattern of closed cells is contemplated, including as examples, patterns in which rectangular shapes and triangular shapes are intermixed; and as another example, patterns in which there are multiple rectangular shapes, including an intermix of square and non-square shapes.

Preferably, each cell 30 includes a plurality of interconnecting walls 40 that extending from top surface 51 of pattern 32 to a surface of substrate 22. These walls 40 define therebetween a substantially closed interior 34. Preferably, the interior of a cell is not in fluid communication with the interior of an adjacent cell, or any other cell. Preferably, the closed interior 34 of the cell receives within it a medium (such as air) only through opening 50 at top surface 51.

Each wall 40 is joined to an adjacent wall 40 at an interior corner 42. Preferably, each interior corner 42 is substantially sharp. However, as can be best seen in FIG. 2b, some amount of rounding or filleting of the corner may occur as a result of fabrication imperfections, or as a result of purposeful design. In the latter case, it is preferable that the radius or fillet in any interior corner be less than about one-tenth of the length of an adjoining wall.

FIG. 2b further shows an example of dimensions a and 2t, which are dimensions useful in calculating roughness parameters as described herein. It is understood that the use herein of a and 2t pertain to square geometry cells 40. With cells of other geometrical shapes, it may be preferable to define the parameters a and 2t as characteristic dimensions generally accepted in the art for the particular type of geometry (examples: a non-square wall will have roughness numbers that take into account the different lengths of opposite cell walls; patterns that are mixes of pentagons and diamond shapes can have yet other characteristic dimensions).

Further, the dimensions shown in Table 1 are by way of example only, and are not meant to be limiting. As one example, various embodiments of the present invention pertain to the use of surface roughness features in the nanometer regime.

The resistance to the Cassie-Wenzel transition on noncommunicating roughness elements-based surfaces can be increased by using nanoscale roughness elements instead of microscale elements. The capillary pressure (which prevents fluid wetting) of a surface generally increases as the feature sizes are reduced. Furthermore, the line density of the crater walls per unit area of the droplet base increases as the length scales of the roughness elements are reduced; this contributes to the increase in the resistance to the Cassie-Wenzel transition. These concepts have been experimentally demonstrated in the present experiments by measuring the transition voltage on cratered surfaces. Surfaces with a crater size of 35 μm require a 20% higher transition electrowetting voltage than similar surfaces of crater sizes 84 μm and higher; this translates to a 44% increase in the electrowetting pressure which the smaller craters can sustain as compared to the larger craters. Surfaces with nanoscale sized elements are expected to show substantially increased resistance to the Cassie-Wenzel transition and exhibit much superior antiwetting properties.

The first set of experiments consisted of studying droplet morphology on the ten cratered surfaces in the absence of an electrowetting (EW) voltage. The nature of the experimentation carried out was similar to the experimentation on pillared surfaces. Deionized (DI) water droplets were dispensed onto the surface and the contact angle was recorded using a goniometer. Droplet states were determined by mechanically dragging the droplet on the surface. The droplet in the Cassie state offered much lower resistance to dragging than a droplet in the Wenzel state. In the Wenzel state, the droplet was almost impossible to drag. The volume of the droplets in all the experiments was less than 5 μl; for this range of droplet sizes, gravity is insignificant as compared to surface forces.

Table 1 shows the droplet morphology on each of the cratered surfaces in the absence of an EW voltage. Surfaces 1-5 were designed such that the Wenzel state was more stable than the Cassie state in the absence of an EW voltage; this was assisted by selecting low crater depths for these surfaces. Droplets dispensed on these surfaces were in the Wenzel state as was clear from the resistance measured to drag a droplet. However the observed contact angles of the droplets did not closely match the predicted Wenzel angles, but were closer to the predicted Cassie angles (as if the droplet was in the Cassie state). This may be explained by assuming that the droplet forms an instantaneous Cassie state when it is dispensed onto the surface; but due to the lower stability of the Wenzel state, the droplet fills the grooves. However, only the craters which are below the original Cassie state are filled and that crater boundaries do not allow liquid to flow into the adjacent air filled craters. The Cassie contact angle is higher than the Wenzel contact angle; consequently, due to the restriction by the crater boundaries, the droplet contact angle will be closer to the Cassie state. The droplet can then said to be in a Wenzel state with a “Cassie-like” angle.

This behavior of the droplet on a cratered surface (with an ordered pattern of closed cells) is in contrast to the observed behavior of the droplet on a pillared surface. Surfaces 6-10 were designed such that the Cassie state was the more stable state, and Table 1 shows that the observed contact angles matched the predicted Cassie angles reasonably well (to within 6%).

Experiments were conducted to verify the hypothesis that cratered surfaces resist transition to the Wenzel state because of the air trapped inside the craters. A DI water droplet was gently deposited on these surfaces and a 125 μm-diameter chrome wire was inserted in the droplet to supply the EW voltage. The voltage was ramped up in steps of 10 V until the occurrence of transition was observed. Droplet transition was estimated by turning off the EW voltage and dragging the droplet. Three experiments were conducted on five surfaces (which had the Cassie state as the more stable state) and the average values of the experimentally observed transition voltages are presented in Table 2.

The experiments to measure the EW transition voltages on cratered surfaces yielded are shown in Table 2. The sixth column in Table 2 shows the EW voltages for transition as predicted by equation 7 (this EW transition voltage does not depend on surface parameters rm and φ); the seventh column represents the experimentally observed transition voltages.

It is seen that the observed transition voltages are approximately three times higher than the predicted transition voltages. These results can be compared to the measurements of the EW transition voltage to trigger the Cassie-Wenzel transition on pillared surfaces. On pillared surfaces, the difference between observed and predicted transition voltages was much lower (typically a voltage difference of less than 35% for each of the five surfaces examined in that work). This comparison directly verifies the hypothesis that cratered surfaces present a higher resistance to the Cassie-Wenzel transition than equivalent pillared surfaces. Also, the measured transition voltage is higher for surface 10 (compared to the other four cratered surfaces) which has the smallest-sized craters (35 μm square). This suggests that cratered surfaces with smaller roughness features offer higher resistance to the Cassie-Wenzel transition; consequently, nanostructured cratered surfaces would be expected to offer higher resistances to droplet transition to the Wenzel state.

TABLE 2
Summary of EW experiments on micro-cratered surfaces
to verify robustness of Cassie state

| | | | | | | | | CA |
|---|---|---|---|---|---|---|---|---|
| | | | | | Transition | Transition | Initial | change at |
| Surface | | | h | a | voltage (V) | voltage (V) | CA | 100 V |
| Number | φ | rₘ | (μm) | (μm) | (predicted) | (observed) | (deg) | (deg) |
| 6 | 0.2 | 2.06 | 42 | 126 | 36.2 | 100 | 157.6 | 22.7 |
| 7 | 0.2 | 4.25 | 85.5 | 84 | 35 | 100 | 144.1 | 23.6 |
| 8 | 0.15 | 2.64 | 85.5 | 177 | 35.2 | 100 | 148.9 | 40 |
| 9 | 0.2 | 3.17 | 85.5 | 126 | 35.4 | 100 | 144.7 | 33 |
| 10 | 0.5 | 5.79 | 85.5 | 35 | 36 | 120 | 131.2 | 4.6 |

The last two columns of Table 2 which show the change in the contact angle at an EW voltage of 100 V. It is seen that the application of the EW voltage does not change the contact angles much (a maximum change of 40 degrees was observed). On equivalent pillared surfaces (with similar values of roughness and φ values), an EW voltage of 100 V resulted in spreading with the contact angle being lower than 90 degrees. The spreading on cratered surfaces was lower and the observed contact angle did not decrease below 108 degrees. Thus, in contrast to pillared surfaces, the droplet did not spread significantly on cratered surfaces; the smallest contact angle in the electrowetted state was 108 degrees (of all the five surfaces tested). This implies that the contact lines are pinned on cratered surfaces as opposed to pillared surfaces and the continuous nature of the crater boundaries severely impedes fluid motion that would advance the droplet contact line. This resistance to fluid motion by the crater boundaries and sharp corners is another reason for the increased robustness of such surfaces.

Technology to prevent Wenzel transition includes designing the surface such that the energy required to transition to the Wenzel state is increased. In some embodiments of the present invention, the Wenzel transition is prevented by designing the surface using non-communicating roughness elements, instead of the commonly used pillar elements (communicating roughness elements). The medium (air in most cases) below the droplet in the Cassie state is trapped because of the noncommunicating nature of the elements and cannot escape; this inhibits transition to the Wenzel state. Use of such surfaces makes the superhydrophobic Cassie state robust, and the possibility of a Wenzel transition resulting from stray vibrations or other forms of energy input is reduced. The droplet can then be transported reliably in the low-friction superhydrophobic state using electrowetting actuation or any other form of actuation.

Table 3 presents the results of EW experiments on the five surfaces (1-5) which had the Wenzel state as the more stable state (in the absence of an EW voltage). It is seen that the contact angle does not show much decrease due to the application of the EW voltage (a maximum change of approximately 23 degrees was observed). This again suggests that the crater boundaries impede fluid motion and discourage the droplet from spreading upon the application of an EW voltage. For all the experiments presented in Table 2 and Table 3, no contact-angle retraction was seen after removal of the EW voltage. This result is again different from the previous experiments on pillared surfaces on which finite contact angle retraction was observed upon the removal of the EW voltage for low-roughness surfaces (rₘ<3). This observation can be attributed to the pinning action of the continuous crater boundaries and sharp corners which discourage fluid movement and discourage droplet retraction when the EW voltage is removed.

TABLE 3
EW experiments on cratered surfaces with the Wenzel state as the more
stable state in the absence of an EW voltage.

| Surface | | | h | a | Initial CA | CA change at 100 V |
|---|---|---|---|---|---|---|
| Number | φ | rₘ | (μm) | (μm) | (deg) | (deg) |
| 1 | 0.2 | 1.41 | 10.8 | 84 | 141.4 | 19.8 |
| 2 | 0.15 | 1.21 | 10.8 | 177 | 151.2 | 23.1 |
| 3 | 0.2 | 1.27 | 10.8 | 126 | 150.2 | 19.8 |
| 4 | 0.5 | 1.60 | 10.8 | 35 | 134.2 | 7.1 |
| 5 | 0.2 | 1.70 | 27.5 | 126 | 141.7 | 18 |

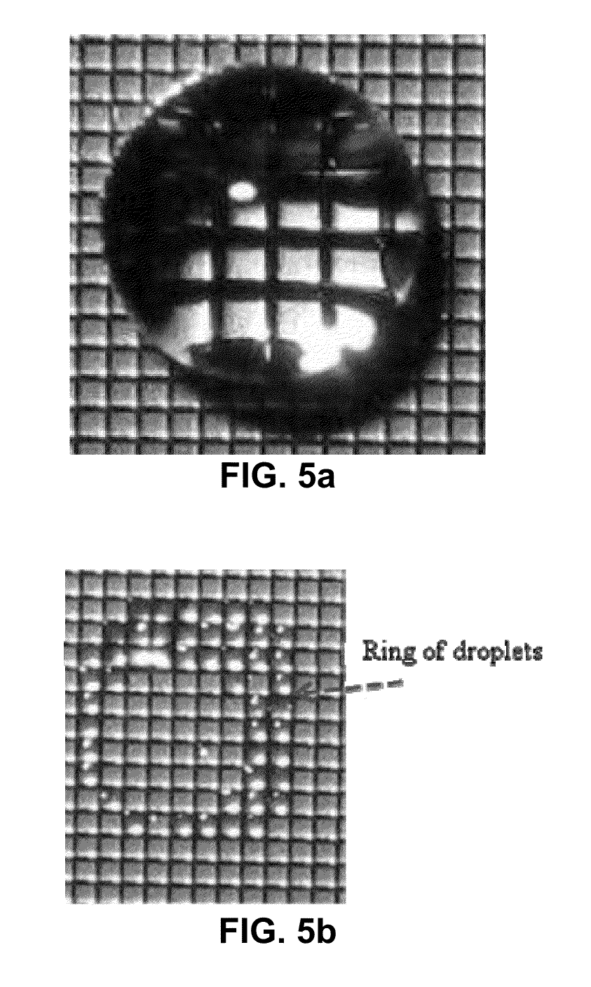

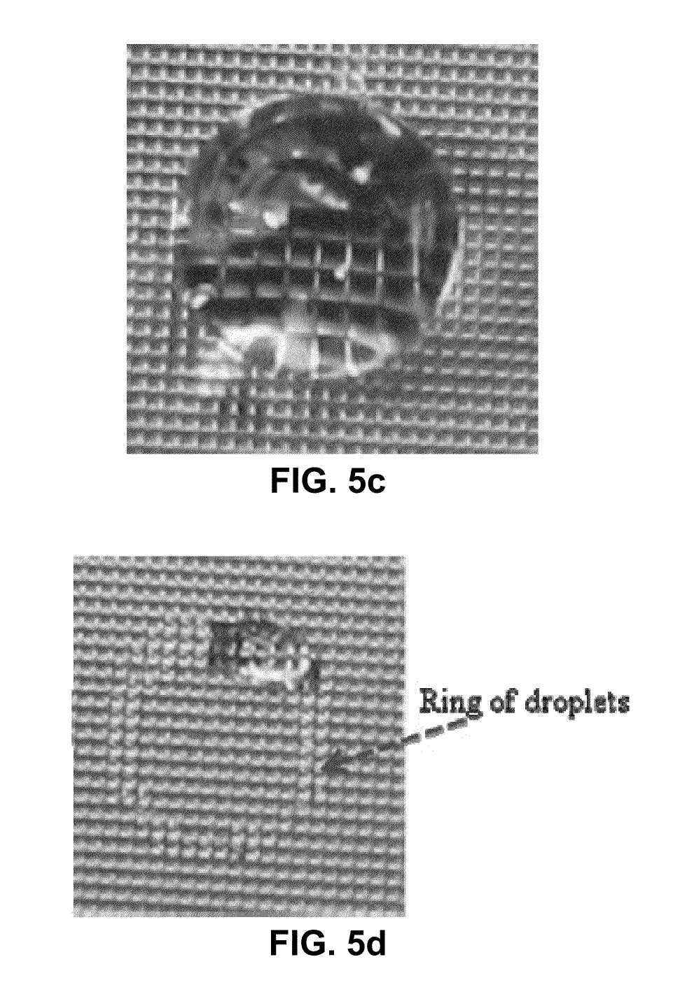

One aspect of the experiments on cratered surfaces pertains to the role of the trapped air during the Cassie-Wenzel transition. No air bubbles were visible when the droplet transitioned to the Wenzel state in any of the experiments. This suggests that air is still trapped beneath the droplet even after the droplet has transitioned to the Wenzel state. The existence of air underneath the droplet was further verified as follows. The droplet in the Wenzel state was gently blown off by directing an air stream on the droplet, tangential to the surface. Upon the removal of the droplet, a ring of small droplets was seen wetting the craters; this ring corresponded to the initial footprint of the droplet in the Cassie state. The micron-sized scale of the craters permitted direct visual confirmation of the existence of these small droplets in the exterior craters. This can be clearly seen in FIGS. 5(a)-(d) which show images of two different surfaces before transition and post transition (after the droplet is blown off). FIGS. 5a and 5c show a droplet on a cratered surface in the Cassie state; FIGS. 5b and 5d show the ring of small droplets inside the craters after the electrowetted droplet was blown off. No liquid was seen inside the craters in the regions corresponding to the interior of the droplet.

These observations suggest that only the periphery of the droplet sinks into the craters upon the application of the EW voltage. The air inside the craters corresponding to the periphery of the droplet can be expelled out (since these craters are less partially covered by the droplet) when the droplet transitions to the Wenzel state. The air trapped in the craters that are more covered by the droplet base (inside the perimeter of the droplet), on the other hand, cannot escape and thus remains trapped beneath the droplet surface even in the Wenzel state. This trapped air inside the craters increases the resistance to the Wenzel state transition, which makes the Cassie state more robust. There is likely compression of the air inside the craters due to the electrowetting pressure.

Structured surfaces with non-communicating roughness elements offer a higher resistance to the Cassie-Wenzel droplet transition than equivalent (communicating) pillared surfaces. The presence of air trapped inside the non-communicating craters and the resistance to fluid motion offered by the crater boundaries and sharp corners are two causes of the increased resistance to the Wenzel transition. Furthermore, the air trapped inside the noncommunicating craters is likely not expelled upon the application of an EW voltage; consequently, even in the Wenzel state, the droplet wets the craters that lie beneath the periphery of the droplet, from where the air can be expelled from the sides. The EW-induced transition thus results in a hybrid droplet state in which the peripheral regions of the droplet are in a ‘Wenzel-like’ state whereas the central regions are in a ‘Cassie-like’ state. The results show that the use of cratered surfaces offers possibilities for the development of robust superhydrophobic surfaces, in which the possibility of a transition to the Wenzel state is greatly minimized. Smaller-sized craters could prevent sinking of the droplet even at the edges.

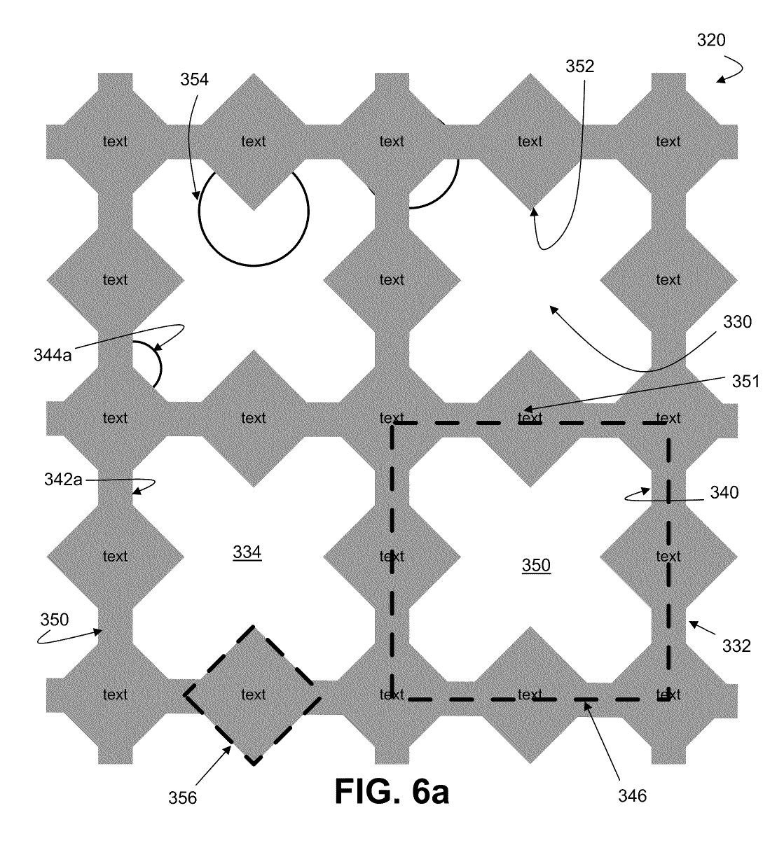

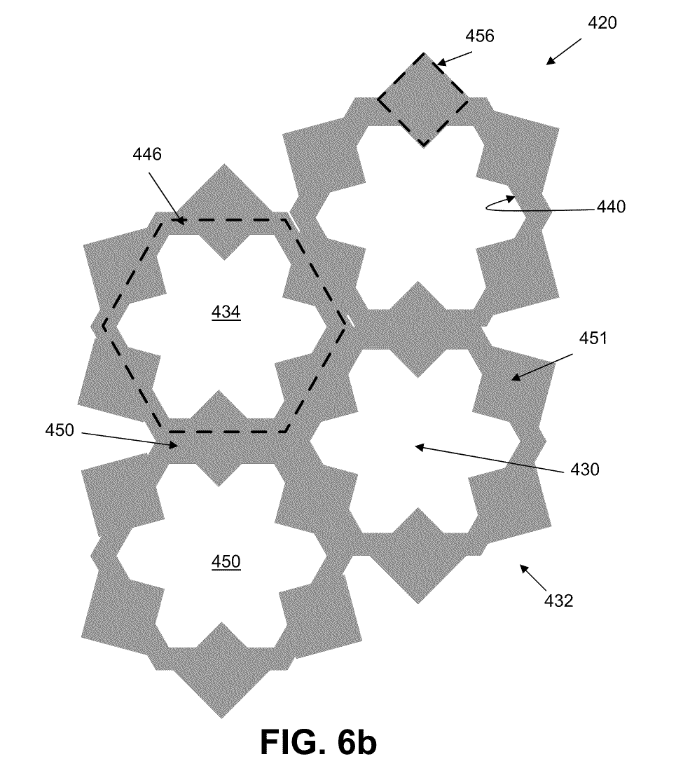

FIGS. 6a and 6b are schematic representations of plan views of four adjacent groupings of surface roughness features according to various embodiments of the present invention. Referring to FIG. 6a, there can be seen four adjacent cells 330, part of an apparatus 320 according to one embodiment of the present invention. Apparatus 320 includes a top surface 351 in which the ordered arrangement 332 includes the superposition of a first, lower ordered shape 346 and a second, higher ordered shape 356. The two shapes combine to generate a plurality of exterior corners 352 that extend inward toward the closed interior 334 of the corresponding cell. Shapes 346 and 356 are both rectangular, although other embodiments of the present invention contemplate shapes of any type, especially those with sharp corners.

In some embodiments, the pattern 332 of FIG. 6a extends downward from the plane of FIG. 6a to a surface of the substrate, such that the surface pattern 352 is also a projection of the interior walls 340 of the cells. However, other embodiments of the present invention include cell walls in the shape of the first shape 346, and with the second shape 356 being present only in a layer on top of the cells. FIG. 6a shows that shape 356 results in the projection of an interior corner 352 defined by an angle 354 that is about 270 degrees. Shape 356 further coacts with shape 346 to generate a plurality of interior angles 342a having an included angle 344a of about 135 degrees. Preferably, the included angle of an interior corner is less than about 145 degrees.

With reference to FIG. 6b, there can be seen four adjacent cells 430, part of an apparatus 420 according to one embodiment of the present invention. Apparatus 420 includes a top surface 451 in which the ordered arrangement 432 includes the super position of a first, lower ordered shape 446 and a second, higher ordered shape 456. The two shapes combine to generate a plurality of exterior corners 452 that extend inward toward the closed interior 434 of the corresponding cell. Shapes 446 and 456 are hexagonal and rectangular, respectively, although FIG. 6b shows only a representative embodiment, and not a limiting embodiment.

In some embodiments, the pattern 432 of FIG. 6b extends (downward from the plane of FIG. 6b) to a surface of the substrate, such that the surface pattern 452 is also a projection of the interior walls 440 of the cells. However, other embodiments of the present invention include cell walls in the shape of the first shape 446, and with the second shape 456 being present only in a layer on top of the cells.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

1. An apparatus for supporting a droplet of liquid, comprising:
a substrate having a layer and a surface, a droplet of the liquid having a contact angle of θ₀ on the surface;
said layer including a plurality of closed cells arranged in a predetermined repetitive order, each said cell being open to the surface, each said cell having a characteristic width a and a characteristic wall thickness 2t such that:
$$φ = 1 - \frac{{a}^{2}}{{( a + 2 t )}^{2}}$$
and the characteristic height h of each said cell is predetermined such that:
$$( Factor ) \times h > [ φ - 1 - \frac{( 1 - φ )}{cos {θ}_{0}} ] \frac{{( a + 2 t )}^{2}}{4 a}$$
wherein Factor is 1.5.

2. The apparatus of claim 1 which further comprises a coating on the surface, such that the contact angle θ₀ of the droplet on the coating is greater than about ninety degrees.

3. The apparatus of claim 1 wherein each cell has a boundary consisting of substantially-straight line segments.

4. The apparatus of claim 1 wherein each cell has a boundary comprising generally-straight line segments.

5. The apparatus of claim 1 wherein the opening of each said cell shape includes a plurality of corners each having an included angle less than about one hundred and twenty degrees.

6. The apparatus of claim 5 wherein each interior corner has an included angle less than about one hundred and ten degrees.

7. The apparatus of claim 5 wherein each interior corner has an included angle less than about ninety-five degrees.

8. The apparatus of claim 1 wherein the corners are interior corners.

9. The apparatus of claim 1 wherein the corners do not have a predetermined radius.

10. The apparatus of claim 1 wherein the corners are sharp corners.

11. The apparatus of claim 1 wherein the opening of each said cell shape includes a plurality of straight features and corners, each corner being the vertex of two features lines.

12. The apparatus of claim 1 wherein Factor is 1.3.

13. The apparatus of claim 1 wherein the value of phi is less than about six tenths.

14. The apparatus of claim 1 wherein the value of phi is less than about one twentieth.

15. The apparatus of claim 1 wherein the value of h is greater than about 2 micrometers.

16. The apparatus of claim 1 wherein a is less than about two hundred micrometers.

17. A method for supporting a droplet of liquid, comprising:
fabricating an ordered, repetitive layer of cells on a substrate, the cells each having a closed interior and an opening, the layer of cells having a supporting surface;
coating the supporting surface of the layer with a hydrophobic material;
establishing a typical geometry for the cells having roughness parameters rₘ and Φ such that:
$$cos {θ}_{0} < - \frac{1 - φ}{{r}_{m} - φ}$$
where θ₀ is the contact angle of a droplet of the liquid on the coated surface;
placing a droplet on the surface;
sealing the openings of a portion of the cells with the droplet; and
trapping air in the closed interior of the portion of the cells.

18. The method of claim 17 wherein the cross sectional shape of each cell is polygonal.

19. The method of claim 17 wherein the opening of each cell is polygonal.

20. The method of claim 17 wherein said establishing includes that phi is less than about six tenths.

21. The method of claim 17 wherein said fabricating is by hard lithography.

22. The method of claim 17 which further comprises supporting the droplet in the Cassie state during said sealing.

23. An apparatus for supporting a droplet of liquid, comprising:
a substrate having a layer and a planar surface;
said layer including a plurality of closed interior cells arranged in a predetermined repetitive order, each said cell having a plurality of generally planar sidewalls defining a volume therebetween, each said cell defining an opening at the surface; and
a coating of material on the surface, the material capable of maintaining the droplet at a contact angle greater than about ninety degrees;
wherein adjacent sidewalls of a cell join to one another at a corresponding one of a first plurality of interior corners, each interior corner having an included angle less than about one hundred twenty degrees, each opening defining at least one exterior corner having an exterior angle greater than about two hundred and forty degrees.

24. The apparatus of claim 23 wherein the plurality of sidewalls is a first plurality, and which further comprises a second plurality of sidewalls each projecting from a corresponding one of a plurality of exterior corners of the surface and extending from the surface of the cell to the bottom of the cell.

25. The apparatus of claim 23 wherein the interior corners of a cell extend from the bottom of the cell to the surface.

26. The apparatus of claim 23 wherein the volume of each said cell is closed except for the opening at the surface.

27. The method of claim 17 wherein said fabricating is by soft lithography.

28. The method of claim 17 wherein said fabricating is by lithography.

29. The apparatus of claim 1 wherein factor is 1.1.
